(19) United States
(12) Patent Application Publication
(10) Pub. No.: US 2007/0292189 A1
(43) Pub. Date: Dec. 20, 2007

(54) Multi-passing apparatus and image forming apparatus having the same

(75) Inventor: Young-choon Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/633,539

(22) Filed: Dec. 5, 2006

(30) Foreign Application Priority Data
Jun. 20, 2006 (KR) 2006-55544

(51) Int. Cl. B41J 13/10; B41J 13/26; B65H 85/00

(52) U.S. Cl. 400/642

(57) ABSTRACT

A multi-passing apparatus to repeatedly transfer a recording medium to an image forming unit to realize a high resolution image and an image forming apparatus including the multi-passing apparatus. The multi-passing apparatus includes a feeding passageway extending from a feeding unit to an image forming unit, a divergent passageway extending from the feeding passageway to support a repeated transfer of a recording medium, and a guide unit to align a front end of the recording medium as the recording medium is transferred through the feeding passageway, and to guide the recording medium so that the recording medium passing the image forming unit for the first time is fed to the divergent passageway.

### CROSS-REFERENCE TO RELATED APPLICATIONS

This application claims priority under 35 U.S.C. §119(a) from Korean Patent Application No. 10-2006-0055544, filed on Jun. 20, 2006, the entire content of which is incorporated herein in its entirety by reference.

### BACKGROUND OF THE INVENTION

1. Field of the Invention

The present general inventive concept relates to an image forming apparatus, and more particularly, to a multi-passing apparatus to repeatedly transfer a recording medium to an image forming unit and an image forming apparatus having the same.

2. Description of the Related Art

Image forming apparatus can be classified into electrophotographic image forming apparatus and ink-jet image forming apparatus. The electrophotographic image forming apparatus forms image information as a latent image on a photosensitive body and transfers the image information onto a recording medium to indirectly form an image. The inkjet image forming apparatus directly transfers or sprays a developer onto a recording medium to form an image.

Such image forming apparatus may skip printing on certain areas of a recording medium due to an inferiority of an image forming unit. Thus, the image quality may be deteriorated.

Accordingly, it is necessary for the image forming apparatus to prevent the occurrence of such non-printed areas, by transferring the recording medium to the image forming unit repeatedly.

### SUMMARY OF THE INVENTION

The present general inventive concept provides a multi-passing apparatus to repeatedly transfer a recording medium, and an image forming apparatus having the multi-passing apparatus.

The present general inventive concept also provides a multi-passing apparatus to guide a recording medium to an image forming passage repeatedly, and to align a front end of the recording medium so that the recording medium is not skewed, and an image forming apparatus having the multi-passing apparatus.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a multi-passing apparatus including a feeding passageway extending from a feeding unit to an image forming unit, a divergent passageway extending from the feeding passageway to support a repeated transfer of a recording medium, and a guide unit to align a front end of the recording medium as the recording medium is transferred through the feeding passageway, and to guide the recording medium so that the recording medium passing the image forming unit for the first time is fed to the divergent passageway.

The guide unit may include at least one guide member formed at the junction of the feeding passageway and the divergent passageway to move between first and second positions, wherein the first position is to transfer the recording medium, with the front end being aligned, and the second position is to connect the feeding passageway with the divergent passageway to form a path through which the recording medium is repeatedly transferred.

The guide unit may further include an elastic member to urge the guide members to maintain the second position.

The guide member may include an aligning surface formed on a first side to align the recording medium, and a guide surface formed on a second side to guide the recording medium to the divergent passageway.

The guide member may include a pair of guide members, which are connected to each other by a bracket.

The foregoing and/or other aspects and utilities of the present general inventive concept are also achieved by providing an image forming apparatus including an image forming unit, a feeding unit to load a recording medium to be fed to the image forming unit, and a multi-passing device to align a front end of the recording medium to feed the recording medium to the image forming unit and to guide the repeated transfer of the recording medium.

The multi-passing device may include a feeding passageway extending from a feeding unit to an image forming unit, a divergent passageway extending from the feeding passageway to support the repeated transfer of a recording medium, and a guide unit to align a front end of the recording medium as the recording medium is transferred through the feeding passageway, and to guide the recording medium so that the recording medium passing the image forming unit for the first time is fed to the divergent passageway.

The guide unit may include at least one guide member formed at the junction of the feeding passageway and the divergent passageway to move between first and second positions, wherein the first position is to transfer the recording medium, with the front end being aligned, and the second position is to connect the feeding passageway with the divergent passageway to form a path through which the recording medium is repeatedly transferred.

The guide unit may further include an elastic member maintaining the guide members in the second position.

The guide member may include an aligning surface formed on a first side to align the recording medium, and a guide surface formed on a second side to guide the recording medium to the divergent passageway.

The guide member may include a pair of guide members, which are connected to each other by a bracket.

The foregoing and/or other aspects and utilities of the present general inventive concept are also achieved by providing a printing media supplying apparatus used with an image forming apparatus, including a feeding unit to feed the printing medium toward an image forming unit, a guide unit to control the feeding direction of the printing medium, a first feeding passageway to guide the printing medium from the feeding unit to the guide unit, a second feeding passageway to guide the printing medium from the guide unit to the printing unit, and a divergent passageway to support a reciprocating movement of the printing medium during a printing operation, the divergent passageway opening up communication with the second feeding passageway by operation of the guide unit.

The guide unit may be disposed at a junction of the first and second feeding passageways to rotate between a first position to supply the printing medium towards the second feeding passageway and a second position to block the first feeding passageway and guide the printing medium towards the divergent passageway.

The guide unit may include a plurality of guide members each including one or more aligning portions to align the printing medium with respect to a printing direction when the guiding unit is in the second position, and one or more first guide portions to guide the reciprocating movement of the printing medium between the divergent passageway and the second feeding passageway when the guide unit is in the second position.

Each guide member may further include one or more second guide portions to guide the printing medium to the second feeding passageway as the guide unit moves from the second position to the first position.

The supplying apparatus may further include an elastic member coupled to the guide unit to resiliently bias the guide unit to the second position.

A driving force of the printing medium supplied toward the image forming unit by the feeding unit may push the guide unit into the first position, and the guide unit may return to the second position when the printing unit passes through the guide unit by the bias force of the elastic member.

The driving force of the printing medium may align the printing medium against the guide unit, and the driving force of the printing medium may be insufficient to push the guide unit into the first position if the printing medium is not aligned with respect to a feeding direction of the printing medium.

The supplying apparatus may further include a first transferring roller installed on the first feeding passageway to supply the printing medium to the second passageway, and a second transferring roller installed on the second feeding passageway to supply the printing medium to the image forming unit and to reciprocate the movement of the printing medium with respect to the image forming unit during the printing operation.

The guide unit may be pivotably mounted to a rotating shaft of the first transferring roller.

The foregoing and/or other aspects and utilities of the present general inventive concept are also achieved by providing a supplying apparatus, including a feeding unit to feed the printing medium toward an image forming unit, a supplying passageway to guide the printing medium toward the image forming unit, a reciprocating passageway to support a reciprocating movement of the printing medium during a printing operation, wherein the reciprocating passageway branches from the supplying passage, a guide unit, disposed on the supplying passageway, to guide the printing medium towards the reciprocating passageway during the reciprocating movement of the printing medium.

The guide unit may rotate between a first position to supply the printing medium toward the image forming unit and a second position to align the printing medium and to guide the printing medium toward the reciprocating passageway.

The guide unit may further include an elastic member to continually bias the guide unit to the second position, and a driving force of the printing medium supplied along the supplying passageway pushes the guide unit to the first position.

The guide unit may return to the second position after the printing medium passes through the guide unit a first time.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a multi-passing apparatus and an image forming apparatus having the multi-passing apparatus according to an exemplary embodiment of the present general inventive concept;

FIG. 2 is a view illustrating a state of a recording medium arranged and fed by the multi-passing apparatus of FIG. 1;

FIG. 3 is a view illustrating a state of the recording medium repeatedly transferred to an image forming unit by the multi-passing apparatus of FIG. 1;

FIG. 4 illustrates a plan view taken along an arrow IV of FIG. 2;

FIG. 5 is a perspective view illustrating the state of the recording medium arranged and fed by the multi-passing apparatus of FIG. 1; and

FIG. 6 is a perspective view illustrating the state of the recording medium repeatedly transferred to the image forming unit by the multi-passing apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

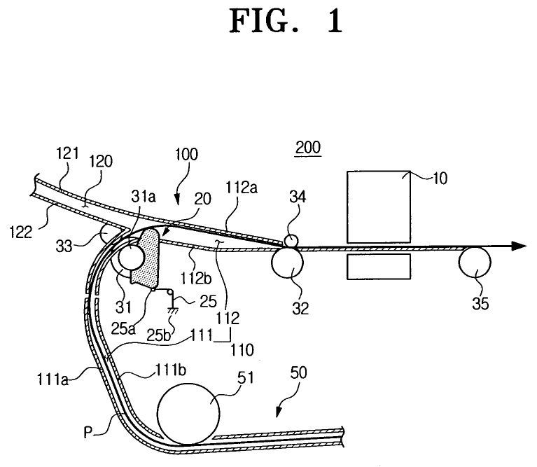

FIG. 1 is a view illustrating an image forming apparatus 200 having a multi-passing apparatus 100, according to an exemplary embodiment of the present general inventive concept. Referring to FIG. 1, the image forming apparatus 200 includes an image forming unit 10, a feeding unit 50, first and second transferring rollers 31 and 32, a delivering roller 35, and the multi-passing apparatus 100. The image forming unit 10 forms an image on a recording medium P. The feeding unit 50 feeds the recording medium P to the image forming unit 10. The first and second transfer rollers 31 and 32 transfer the recording medium P fed through the feeding unit 50. The delivering roller 35 is disposed under the image forming unit 10. The multi-passing apparatus 100 arranges a front end of the recording medium P fed by the feeding unit 50 and guides a repeated transfer of the recording medium P.

The image forming unit 10 may be an image forming unit using various image forming methods, such as an electrophotographic method using a photosensitive medium or the like, an ink-jet method using a print head or the like, or a thermal transfer method using an ink ribbon or the like.

The feeding unit 50 loads the recording medium P to be fed to the image forming unit 10 therein and includes a feeding roller 51 to feed the recording medium P.

Support rollers 33 and 34 are respectively disposed opposite to the first and second transferring rollers 31 and 32.

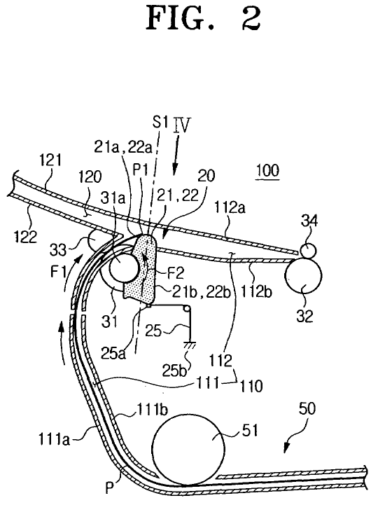

The multi-passing apparatus 100 of FIG. 1 is also illustrated in FIGS. 2, 3, 5, and 6.

As illustrated in FIGS. 1, 2, and 3, the multi-passing apparatus 100 includes a feeding passageway 110, at least one divergent passageway 120, and a guide unit 20. The feeding passageway 110 is disposed to feed the recording medium P from the feeding unit 50 to the image forming unit 10. The divergent passageway 120 diverges from a downstream portion of the feeding passageway 110. The guide unit 20 arranges a front end P1 (see FIG. 2) of the recording medium P transferred through the feeding passageway 110 and guides the recording medium P, which has been first transferred to the image forming unit 10, toward the divergent passageway 120.

The feeding passageway 110 extends from the feeding unit 50 to the image forming unit 10, and the recording medium P is picked up by the feeding roller 51 of the feeding unit 50 and then guided to the image forming unit 10 through the feeding passageway 110.

The first and second transferring rollers 31 and 32 are installed on the feeding passageway 110. The feeding passageway 110 includes first and second feeding passageway 111 and 112. The first feeding passageway 111 extends from the feeding unit 50 to the first transferring roller 31, and the second feeding passageway 112 extends from the first transferring roller 31 to the image forming unit 10. Access to the first and second feeding passageways 111 and 112 by the recording medium P is controlled by the guide unit 20.

The first feeding passageway 111 includes front and rear guide surfaces 111a and 111b forming a space through which the recording medium P is transferred. The second feeding passageway 112 includes upper and lower guide surfaces 112a and 112b forming a space through which the recording medium P is transferred.

The divergent passageway 120 guides the recording medium P so that the recording medium P is repeatedly transferred to the image forming unit 10. The divergent passageway 120 may be installed so that the recording medium P is unfolded and then repeatedly transferred. In other words, the divergent passageway 120 intersects with the second feeding passageway 112.

The divergent passageway 120 includes upper and lower guide surfaces 121 and 122 forming a space through which the recording medium P is transferred.

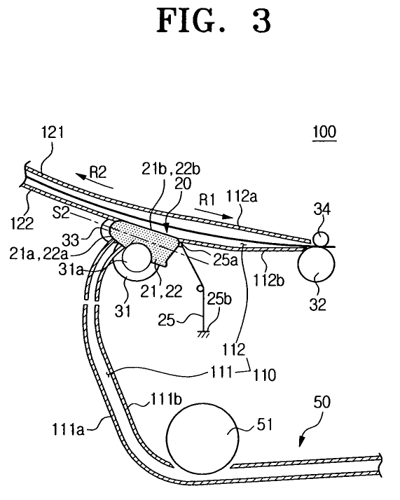

The guide unit 20 is installed to move between first and second positions S1 and S2 respectively illustrated in FIGS. 2 and 3. The guide unit 20 moves to the first position S1 so as to feed the recording medium P to the image forming device 10 and arrange the recording medium P. The guide unit 20 moves to the second position S2 so as to repeatedly transfer the recording medium P to the image forming unit 10.

The guide unit 20 includes at least one or more guide members. As illustrated in FIGS. 2-6, the guide unit 20 may include guide members 21 and 22. The guide members 21 and 22 pivot at an intersecting point between the feeding passageway 110 and the divergent passageway 120 along a direction F2 opposite to a direction F1 along which the recording medium P is fed as illustrated in FIG. 2.

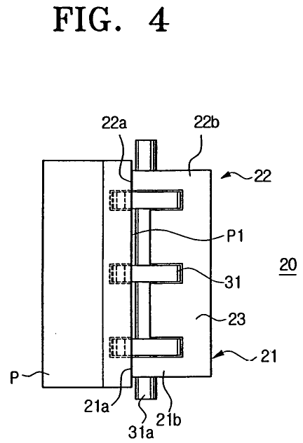

The guide unit 20 may include a pair of guide members 21 and 22 which are connected to each other and pivot together by a bracket 23 as illustrated in FIG. 4.

The guide members 21 and 22 may pivot by a recovery force of an elastic member 25 along the direction F2 opposite to the direction F1 along which the recording medium P is fed. The elastic member 25 may be a coil spring, a torsion spring, a plate spring, or the like.

The elastic member 25 may include a first end 25a fixed to ends of the guide members 21 and 22 and a second end 25b fixed to a body of the image forming apparatus 200. The elastic member 25 elastically urges the guide members 21 and 22 to pivot along the direction F2 opposite to the direction F1 along which the recording medium P is fed.

The guide members 21 and 22 may be pivotably supported on a rotary shaft 31a of the first transferring roller 31 and pivot on the rotary shaft 31a of the first transferring roller 31 by the recovery force of the elastic member 25.

The guide members 21 and 22 respectively include arrangement surfaces 21a and 22a on their sides and guide surfaces 21b and 22b on other sides as illustrated in FIGS. 2-6.

If the feeding roller 51 of the feeding unit 50 and the first transferring roller 31 are driven to feed the recording medium P through the feeding passageway 110 along the direction F1 indicated by an arrow of FIG. 2, the guide members 21 and 22 pivot along the direction F1 by a transfer force of the recording medium P to move to the first position S1 connecting the first and second feeding passageways 111 and 112.

When the front end P1 of the recording medium P is not arranged along a width direction in the first position S1, i.e. the recording medium P is skewed with respect to the width direction of the first position S1, the guide members 21 and 22 pivot along the direction F2 of FIG. 2 by the recovery force of the elastic member 25. The guide members 21 and 22 uniformly press on the front end P1 of the recording medium P toward the width direction due to the pivot force as illustrated in FIG. 4 to arrange the front end P1 of the recording medium P to an alignment position.

If a rear end of the recording medium P completely passes the guide member 21 and 22, the guide members 21 and 22 pivot along the direction F2 of FIG. 2 opposite to the direction F1 of FIG. 2 along which the recording medium P is fed due to the recovery force of the elastic member 25 so that the guide surfaces 21b and 22b of the guide members 21 and 22 move to the second position S2 which connects the divergent passageway 120 and the second feeding passageway 112 as illustrated in FIG. 3.

While the recording medium P is repeatedly transferred along directions R1 and R2 indicated by arrows in FIG. 3 while in the second position S2 of the guide members 21 and 22 by the movement of the second transferring roller 32, the image forming unit 10 can form an image on the recording medium P and prevent the occurrence of non-printed areas.

The guide members 21 and 22 moved to the second position S2 close the connection between the first and second feeding passageways 111 and 112 to block the entrance of the recording medium P into the first feeding passageway 111.

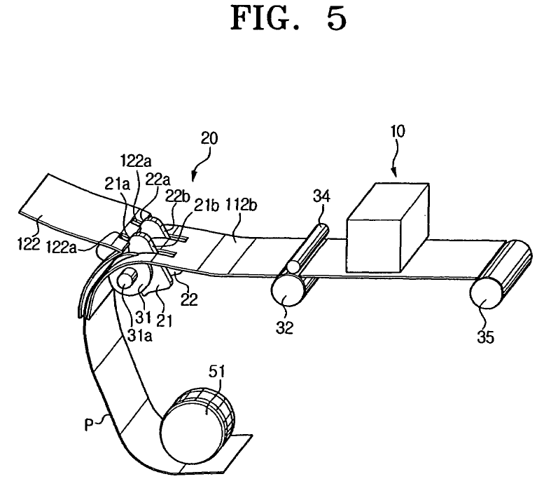

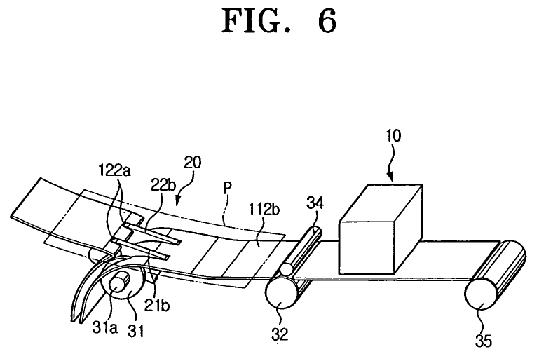

As illustrated in FIGS. 5 and 6, insertion grooves 122a may be formed in the lower guide surface 122 of the divergent passageway 120 adjacent to front ends of the guide members 21 and 22. The guide members 21 and 22 are inserted into the insertion grooves 122a. Thus, the divergent passageway 120 and the second feeding passageway 112 may form a further gentle guide surface.

According to exemplary embodiments of the present general inventive concept, a recording medium P can be guided along an image forming passage repeatedly, and the recording medium P is well aligned with respect to a feeding direction so that it is not skewed when fed to the image forming unit.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A multi-passing apparatus comprising:
a feeding passageway extending from a feeding unit to an image forming unit;
a divergent passageway extending from the feeding passageway to support a repeated transfer of a recording medium; and
a guide unit to align a front end of the recording medium as the recording medium is transferred through the feeding passageway, and to guide the recording medium so that the recording medium passing the image forming unit for the first time is fed to the divergent passageway.

2. The multi-passing apparatus of claim 1, wherein the guide unit comprises at least one guide member formed at the junction of the feeding passageway and the divergent passageway to move between first and second positions, wherein the first position is to transfer the recording medium, with the front end being aligned, and the second position is to connect the feeding passageway with the divergent passageway to form a path through which the recording medium is repeatedly transferred.

3. The multi-passing apparatus of claim 2, wherein the guide unit further comprises an elastic member to urge the guide members to maintain the second position.

4. The multi-passing apparatus of claim 2, wherein the guide member comprises an aligning surface formed on a first side to align the recording medium, and a guide surface formed on a second side to guide the recording medium to the divergent passageway.

5. The multi-passing apparatus of claim 2, wherein the guide member comprises a pair of guide members, which are connected to each other by a bracket.

6. An image forming apparatus comprising:
an image forming unit;
a feeding unit to load a recording medium to be fed to the image forming unit; and
a multi-passing device to align a front end of the recording medium to feed the recording medium to the image forming unit and to guide the repeated transfer of the recording medium.

7. The image forming apparatus of claim 6, wherein the multi-passing device comprises:
a feeding passageway extending from a feeding unit to an image forming unit;
a divergent passageway extending from the feeding passageway to support the repeated transfer of a recording medium; and
a guide unit to align a front end of the recording medium as the recording medium is transferred through the feeding passageway, and to guide the recording medium so that the recording medium passing the image forming unit for the first time is fed to the divergent passageway.

8. The image forming apparatus of claim 7, wherein the guide unit comprises at least one guide member formed at the junction of the feeding passageway and the divergent passageway to move between first and second positions, wherein the first position is to transfer the recording medium, with the front end being aligned, and the second position is to connect the feeding passageway with the divergent passageway to form a path through which the recording medium is repeatedly transferred.

9. The image forming apparatus of claim 8, wherein the guide unit further comprises an elastic member to urge the guide members to maintain the second position.

10. The image forming apparatus of claim 8, wherein the guide member comprises an aligning surface formed on a first side to align the recording medium, and a guide surface formed on a second side to guide the recording medium to the divergent passageway.

11. The image forming apparatus of claim 8, wherein the guide member comprises a pair of guide members, which are connected to each other by a bracket.

12. A printing media supplying apparatus used with an image forming apparatus, comprising:
a feeding unit to feed the printing medium toward an image forming unit;
a guide unit to control the feeding direction of the printing medium;
a first feeding passageway to guide the printing medium from the feeding unit to the guide unit;
a second feeding passageway to guide the printing medium from the guide unit to the printing unit; and
a divergent passageway to support a reciprocating movement of the printing medium during a printing operation, the divergent passageway opening up communication with the second feeding passageway by operation of the guide unit.

13. The supplying apparatus of claim 12, wherein the guide unit is disposed at a junction of the first and second feeding passageways to rotate between a first position to supply the printing medium towards the second feeding passageway and a second position to block the first feeding passageway and guide the printing medium towards the divergent passageway.

14. The supplying apparatus of claim 13, wherein the guide unit comprises a plurality of guide members each comprising:
one or more aligning portions to align the printing medium with respect to a printing direction when the guiding unit is in the second position; and
one or more first guide portions to guide the reciprocating movement of the printing medium between the divergent passageway and the second feeding passageway when the guide unit is in the second position.

15. The supplying apparatus of claim 14, wherein each guide member further comprises one or more second guide portions to guide the printing medium to the second feeding passageway as the guide unit moves from the second position to the first position.

16. The supplying apparatus of claim 13, further comprising:
an elastic member coupled to the guide unit to resiliently bias the guide unit to the second position.

17. The supplying apparatus of claim 16, wherein a driving force of the printing medium supplied toward the image forming unit by the feeding unit pushes the guide unit into the first position, and the guide unit returns to the second position when the printing unit passes through the guide unit by the bias force of the elastic member.

18. The supplying apparatus of claim 17, wherein the driving force of the printing medium aligns the printing medium against the guide unit, and the driving force of the printing medium is insufficient to push the guide unit into the first position if the printing medium is not aligned with respect to a feeding direction of the printing medium.

19. The supplying apparatus of claim 12, further comprising:
a first transferring roller installed on the first feeding passageway to supply the printing medium to the second passageway; and
a second transferring roller installed on the second feeding passageway to supply the printing medium to the image forming unit and to reciprocate the movement of the printing medium with respect to the image forming unit during the printing operation.

20. The supplying apparatus of claim 19, wherein the guide unit is pivotably mounted to a rotating shaft of the first transferring roller.

21. A supplying apparatus, comprising:
a feeding unit to feed the printing medium toward an image forming unit;
a supplying passageway to guide the printing medium toward the image forming unit;
a reciprocating passageway to support a reciprocating movement of the printing medium during a printing operation, wherein the reciprocating passageway branches from the supplying passage; and
a guide unit, disposed on the supplying passageway, to guide the printing medium towards the reciprocating passageway during the reciprocating movement of the printing medium.

22. The supplying apparatus of claim 21, wherein the guide unit rotates between a first position to supply the printing medium toward the image forming unit and a second position to align the printing medium and to guide the printing medium toward the reciprocating passageway.

23. The supplying apparatus of claim 22, further comprising:
an elastic member to continually bias the guide unit to the second position, and a driving force of the printing medium supplied along the supplying passageway pushes the guide unit to the first position.

24. The supplying apparatus of claim 23, wherein the guide unit returns to the second position after the printing medium passes through the guide unit a first time.
